(19) United States
(12) Patent Application Publication
(10) Pub. No.: US 2011/0080304 A1
(43) Pub. Date: Apr. 7, 2011

(54) Vehicle Park Assist System and Method for Parking a Vehicle Using Such System

(75) Inventors: Salvador Toledo, Ypsilanti, MI (US); Janet Meise, Koln (DE); Kay C. Müller, Koln (DE); Torsten Wey, Moers (DE); Dirk Gunia, Pulheim (DE); Holger Mueller, Koln (DE); Marcus Kalabis, Krefeld (DE)

(73) Assignee: FORD GLOBAL TECHNOLOGIES, LLC, Dearborn, MI (US)

(21) Appl. No.: 12/574,834

(22) Filed: Oct. 7, 2009

(51) Int. Cl. B60Q 1/48; G08G 1/14

(52) U.S. Cl. 340/932.2; 701/41

(57) ABSTRACT

A method for parking a vehicle in a parking spot comprises the steps of: providing a vehicle having a sensing system and a park assist system, the sensing system including a sensor which provides an input signal; scanning neighboring objects to determine if a feasible target parking space is available; determining whether there is a sufficient slot length in which to park the vehicle and calculating a trajectory path to guide the vehicle into the space; starting a parking maneuver; deactivating the assist system by a driver/passenger action; storing the parking information determined above; and requesting a driver command to resume the parking maneuver, wherein if the driver selects to resume the parking maneuver the assist system uses the stored parking information to guide the vehicle into the space.

### BACKGROUND OF THE INVENTION

This invention relates in general to vehicle park assist systems and in particular to an improved park assist system and method for parking of such a vehicle.

Vehicle park assist systems are used to identify a feasible parking space, e.g., a parallel parking space or a garage parking space, and then take over the steering of the vehicle to maneuver the vehicle into the identified space hands free. During operation, the driver still shifts the transmission and operates the gas and brake pedals. Thus, while the steering is done automatically, the driver is still responsible for safe parking of the vehicle.

One known vehicle park assist system is disclosed in U.S. Pat. No. 7,526,368 to Endo et al. and includes an electronic control unit (ECU) for parking assistance, a back camera connected to the ECU, a touch display connected to the ECU, and an electric power assisted steering (EPS) apparatus connected to the ECU. In operation, the back camera takes an image of an area extending on a rear side of the vehicle and supplies the image information around the rear of the vehicle to the parking assistance ECU. The parking assistance ECU displays a real picture taken by the back camera to the touch display when a shift position of the vehicle is at a reverse position. The touch display is provided with a touch operation part of a pressure sensitive type of a temperature sensitive type which enables operation by the vehicle driver to set a target parking position on the display by displacing the picture of the vehicle taken by the back camera into a parking space frame on the touch display. In the Endo et al. system, after the target parking position is set by the driver via manual manipulation of the vehicle into a parking space frame on the touch display, the parking assistance ECU performs an automatic steering of the EPS along a calculated path to the target parking position.

In the Endo et al. system, if the guidance of the vehicle to the target parking position is cancelled, a memory of the ECU, which continuously holds the target parking position even after the cancellation condition is established, allows the driver via manual touch operation of the touch display, to reset the target parking position to an absolute position. The absolute position can be the same as the target parking position before guidance was cancelled. Thus, the vehicle can be parked to the original target parking position following cancellation without having to restart the parking process again by the driver having to manually reset the target parking position via the manual manipulation of the vehicle into a parking space frame on the touch display. Unfortunately, this type of system in Endo et al. is camera based in that it requires a back camera and also the system requires a touch display which requires driver input. Thus, it would be desirable to provide a park assist system which did not require a back camera and/or a touch display.

### SUMMARY OF THE INVENTION

This invention relates to an improved park assist system and method for parking of such a vehicle which is a sensor based park assist system that provides the driver the option of resuming the functionality provided by the park assist system after it has been deactivated by the driver. According to one embodiment, a method for parking a vehicle in a target parking spot comprising the steps of: (a) providing a vehicle having a sensing system and a park assist system operatively connected thereto, the sensing system including at least one sensor which provides an input signal to the park assist system; (b) scanning neighboring objects using the sensor to determine if a feasible target parking space is available for parking the vehicle; (c) using a computer of the park assist system to determine whether there is a sufficient slot length in which to park the vehicle in the target parking space and to determine a calculated trajectory path to guide the vehicle into the target parking space, the park assist system alone determining the target parking space and the calculated trajectory path thereto without any driver interaction; (d) starting a parking maneuver wherein the vehicle is started to be guided into the target parking space by the park assist system; (e) following step (d), deactivating the park assist system by a driver/passenger action; (f) at the time of deactivation of step (e), storing the parking information determined above in step (c) by the park assist system; and (g) following step (f), the park assist system requesting a driver command to resume the parking maneuver began in step (d), wherein if the driver selects to resume the parking maneuver the park assist system uses the stored parking information to guide the vehicle into the target parking space.

According to another embodiment, a method for parking a vehicle in a target parking spot comprising the steps of: (a) providing a vehicle having a sensing system, a park assist system operatively connected to the sensing system, a steering system including a steering wheel, and a powertrain system, the sensing system including at least one sensor which provides an input signal to the park assist system; (b) activating the sensing system to scan neighboring objects to determine if there is a feasible target parking space available for parking of the vehicle; (c) using a computer of the park assist system to determine whether there is a sufficient slot length in which to park the vehicle in the target parking space and to determine a calculated trajectory path to guide the vehicle into the target parking space, the park assist system alone determining the target parking space and the calculated trajectory path thereto without any driver interaction; (d) prompting the driver that a feasible target parking space is available; (e) instructing the driver to stop the vehicle, remove their hands from the steering wheel of the steering system, and engage the powertrain system into reverse; (f) starting a parking maneuver wherein the vehicle is started to be guided into the target parking space by the park assist system; (g) following step (f), deactivating the park assist system by a driver/passenger action; (h) at the time of deactivation of step (g), storing the parking information determined above in step (c) by the park assist system; and (i) following step (h), the park assist system requesting a driver command to resume the parking maneuver began in step (f), wherein if the driver selects to resume the parking maneuver the park assist system uses the stored parking information to guide the vehicle into the target parking space.

According to yet another embodiment, a park assist system for parking a vehicle in a target parking space comprises: a sensing system including at least one sensor which provides an input signal to the park assist system to determine if a feasible target parking space is available for parking the vehicle; and a park assist system computer which determines whether there is a sufficient slot length in which to park the vehicle in the target parking space and to determine a calculated trajectory path to guide the vehicle into the target parking space, the park assist system alone determining the target parking space and the calculated trajectory path thereto without any driver interaction, the computer having a stored memory that can be retrieved upon deactivation of the park assist system; wherein upon starting a parking maneuver in which the vehicle is started to be guided into the target parking space by the park assist system and the system is deactivated by a driver/passenger action, at the time of deactivation the computer of the park assist system stores the parking information determined above and requests a driver command to resume the parking maneuver which has began and, if the driver selects to resume the parking maneuver the park assist system uses the stored parking information, the park assist system is operative to guide the vehicle into the target parking space.

Other advantages of this invention will become apparent to those skilled in the art from the following detailed description of the preferred embodiments, when read in light of the accompanying drawings.

### BRIEF DESCRIPTION OF THE DRAWINGS

FIG. 1 is a schematic diagram of a first embodiment of a path to a target parking space using a park assist system according to the present invention.

FIG. 2 is a schematic diagram of a portion of the park assist system illustrated in FIG. 1, showing the associated vehicle used therewith.

FIG. 3 is a flow chart of an embodiment of a method for parking a vehicle using the park assist system of the present invention.

### DETAILED DESCRIPTION OF THE PREFERRED EMBODIMENTS

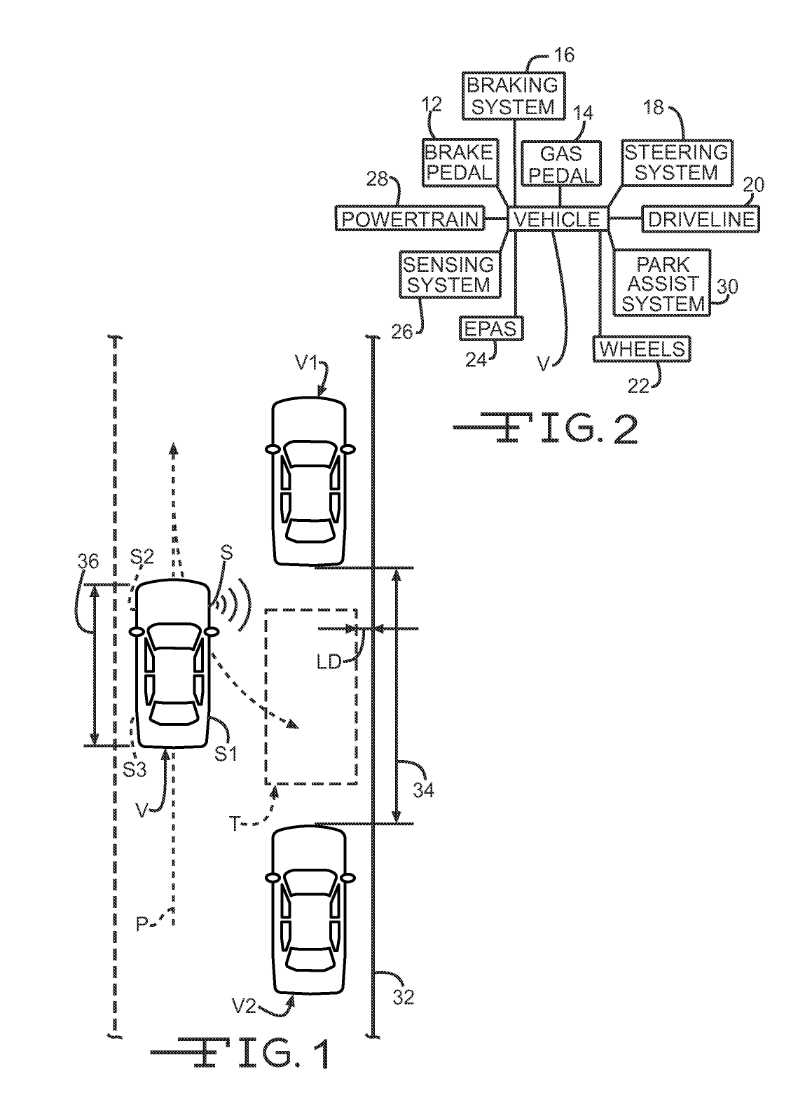

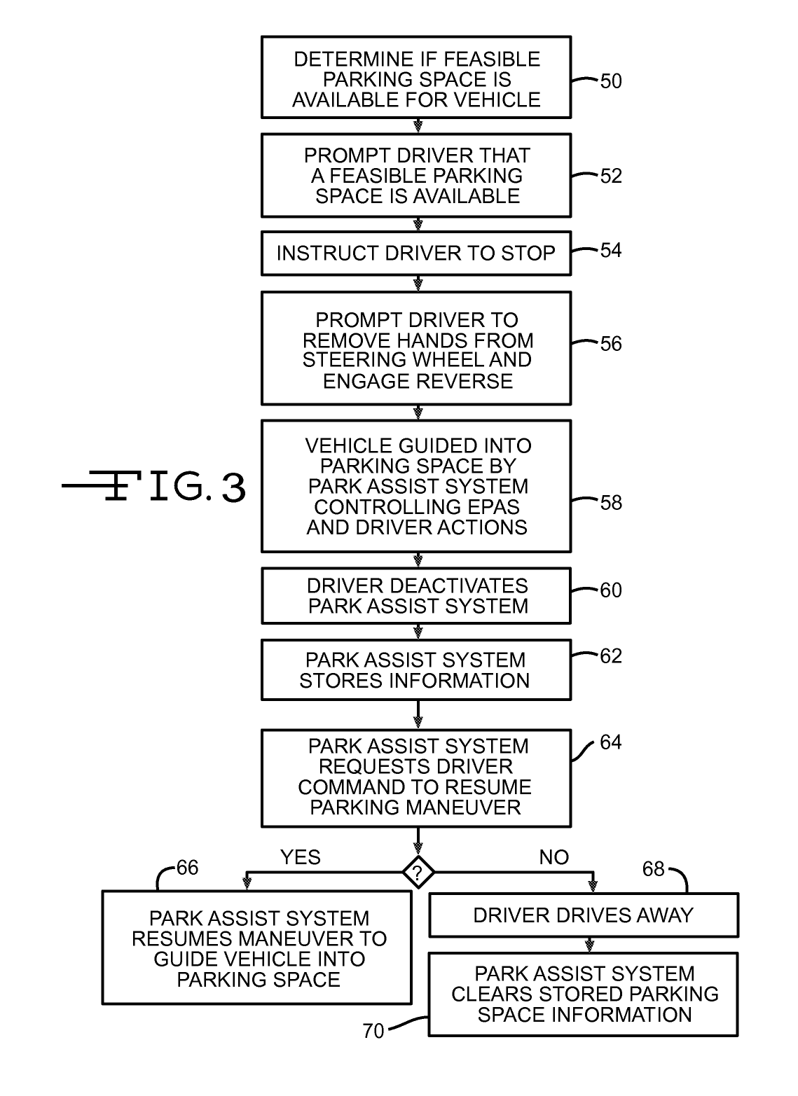

Referring now to FIG. 1, there is illustrated a schematic diagram of a first embodiment of a path P for parking of a vehicle V to a target parking space or spot T between two parked vehicles V1 and V2, using a park assist system, which will be described in detail below, according to the present invention. In the illustrated embodiment, the vehicle V, schematically shown in FIG. 2, includes at least the following components or systems: a brake pedal 12, a gas pedal 14, a braking system 16, a steering system 18, a driveline system 20, wheels 22, an electric (EPAS) or electro-hydraulic power assisted steering (EHPAS) system 24 which is part of the steering system 18, a sensing system 26, a powertrain system 28, and a park assist system 30. However, it must be understood that the vehicle V to be parked may include any other suitable components or systems and that only those components or systems which are necessary for describing and explaining the function and operation of the present invention are illustrated herein. Also, in the illustrated embodiment the target parking space T is shown as being a parallel parking space located between two parked vehicles V1 and V1 on the passenger or vehicle right hand side; however, the target parking space T may be any other suitable parking space and is not limited to the parking space shown in the illustrated embodiment.

In the illustrated embodiment, the sensing system 26 is operatively connected to the park assist system 30 to provide input signal(s) thereto and preferably includes ultrasonic sensors, odometric sensors, and an absolute steering wheel angle sensor. The ultrasonic sensors may be located on a side(s) of a front and/or rear bumpers of the vehicle V. In the illustrated embodiment of FIG. 1, an ultrasonic sensor, indicated generally at S is illustrated schematically as being located at least on a front passenger or right side bumper of the vehicle V. Alternatively, the number and or the location of the ultrasonic sensors may be other than illustrated if so desired. For example, one or more ultrasonic sensors may be located on the front driver side bumper of the vehicle V (as shown at S2 in FIG. 1), on one or both of the rear bumpers of the vehicle (as shown as S1 and S3 in FIG. 1), or in any suitable combinations of or desired locations thereof on the vehicle V. Also, the types of sensors may be other than illustrated and described. For example, a relative steering wheel angle sensor may be used instead of the absolute steering wheel angle sensor; others sensors, such as for example, radar, thermal, optical (e.g., Light Detection and Ranging (LIDAR), and laser may be used instead of or in combination with the ultrasonic side sensors; and/or a global positioning system (GPS) may be used instead of the odometric sensors.

In the illustrated embodiment, the odometric sensors may be located on one or more of the wheels 22 of the vehicle V and/or in the driveline system 20 of the vehicle. The absolute steering wheel angle sensor is located on the steering system 18 of the vehicle and preferably is located on a steering wheel of the steering system 18. Alternatively, the construction and/or the components of the sensing system 26 of the vehicle V may be other than illustrated and described if so desired.

In the illustrated embodiment, the vehicle V is parked into the target parking space T using the park assist system 30 of the present invention. To accomplish this, at least one of the ultrasonic sensors is used in conjunction with the odometric sensors and the absolute steering wheel angle sensor to scan neighboring objects and their location relative to the position of the vehicle V as a driver of the vehicle drives by them. In the illustrated embodiment of FIG. 1, the neighboring objects are illustrated as being the two parked vehicles V1 and V2 and an object 32, such as for example, a curb or a wall. However, one or more of the neighboring objects may be omitted or may be of other kinds or types than that which are illustrated and described.

The information from the sensors is processed by a computer of the park assist system 30 to determine if a valid path trajectory can be performed to park the vehicle V into the target parking space T. The calculation by the computer of the park assist system 30 not only includes a determination of a slot length 34 depending upon a length 36 of the vehicle V, but also considers if there is sufficient space to maneuver the vehicle V into the target parking space T.

Referring now to FIG. 3, there is illustrated a flow chart of an embodiment of a method for parking a vehicle using the park assist system 30 of the present invention. As shown in FIG. 3, the method of the present invention includes a first step 50 in which the computer of the park assist system 30 determines if there is a feasible target parking space T available for parking of the vehicle V. To accomplish this, the park assist system 30 uses the sensing system 26. As discussed above, the sensing system 26 determines whether there is a sufficient slot length 34 in which to park the vehicle V.

Once it is determined that a suitable target parking space T has been identified by the park assist system 30 in step 50, the park assist system 30 in step 52 prompts the driver via a visual and/or audible interface that a feasible target parking space T is available. Next, in step 54, the driver is instructed by the park assist system 30, either visually and/or audibly, to stop in order to accept the assistance to park.

After the driver has stopped in step 54, the park assist system 30 in step 56 will ask or prompt the driver to remove their hands from a steering wheel of the steering system 18 and engage/shift the transmission of the powertrain system 28 into reverse. Once the driver has removed their hands from the steering wheel and engaged reverse, the park assist system 30 in step 58 will take over the steering wheel movement and control the EPAS system 24 to execute the calculated steering trajectory based on the relative vehicle position to the neighboring objects, i.e., in FIG. 1 the vehicles V1 and V2 and the object 32.

Following this, if during step 58 the driver (and/or a passenger) performs an action which is effective to cause a deactivation (or interruption and/or cancellation as described below), of the parking of the vehicle V along the calculated steering trajectory path, then the park assist system 30 will be deactivated in step 60. The action by the driver (and/or passenger) during step 60 which may be effective to cause the deactivation of the park assist system 30 may be caused, for example, by the driver grabbing the steering wheel (as sensed by a steering wheel torque and/or angle sensor), by the driver and/or a passenger opening a door of the vehicle, or by the driver pressing a button (i.e., activation/deactivation button) of the park assist system 30 during step 58. Alternatively, there may be other kinds of suitable actions and/or events, either caused by the driver and/or a passenger or caused without any driver and/or passenger action, such as engine stall, that may occur besides those described above that can also be effective to deactivate, interrupt and/or cancel the park assist system 30 during its automatic parking operation in step 58.

Upon the deactivation of the park assist system 30, the computer of the park assist system 30 in step 62 stores and retains in a memory thereof, the location of the vehicle V at the time of deactivation relative to the information it obtained during step 50 (i.e., the neighboring objects and their location) as well as the calculated trajectory path (based on the relative vehicle position to such neighboring objects), that the vehicle V was travelling at the time of deactivation. Preferably, the memory of the computer of the park assist system 30 is a non-volatile type of memory which enables the stored information to remain available even if the vehicle loses power in the case of an engine stall; however, other types of memory may be used if so desired.

Next, the park assist system 30 in step 64 requests from the driver via preferably via a visual an/or audible command whether the driver desires to resume the parking maneuver of the vehicle along the calculated trajectory path to the target parking space T. If the driver indicates that he/she desires to resume the parking maneuver, in step 66 the park assist system resumes the parking maneuver using the stored information in the computer of the park assist system 30 to guide the vehicle V into the target parking space T. The driver may indicate that they desire to resume the parking maneuver by any suitable means, such as for example, by an audible command or by a mechanical command, such as for example, by pressing a button of the park assist system 30. During step 66, the park assist system 30 will prompt the driver when to stop and pull forward and/or backwards as needed until the vehicle V is finally parked in the target parking space T. On the other hand, if the driver does not indicate that he/she desires to resume the parking maneuver in the manner described above and/or rather simply drives away in step 68, then the park assist system in step 70 after recognizing this will clear the stored parking information from the park assist system 30 that was stored in step 62.

One advantage of the embodiment of the present invention is that the park assist system and method of the operation thereof is capable of providing a sensor based park assist system that provides the driver the option of resuming the functionality provided by the park assist system after it has been deactivated by the driver. As a result of this, the park assist system can still park the vehicle in the target parking space using the stored parking information in the computer of the system without making the driver restart the parking operation over again from the beginning. Also, the park assist system of the present invention alone determines the target parking space and the calculated trajectory path thereto without any driver interaction, i.e., the driver does not have to manually position the vehicle in the target parking space on a touch display screen of the park assist system such as in the system disclosed in Endo et al. '368 patent.

In accordance with the provisions of the patent statutes, the principle and mode of operation of this invention have been described and illustrated in its preferred embodiments. However, it must be understood that this invention may be practiced otherwise than as specifically explained and illustrated without departing from its spirit or scope.

What is claimed is:

1. A method for parking a vehicle in a target parking spot comprising the steps of:
(a) providing a vehicle having a sensing system and a park assist system operatively connected thereto, the sensing system including at least one sensor which provides an input signal to the park assist system;
(b) scanning neighboring objects using the sensor to determine if a feasible target parking space is available for parking the vehicle;
(c) using a computer of the park assist system to determine whether there is a sufficient slot length in which to park the vehicle in the target parking space and to determine a calculated trajectory path to guide the vehicle into the target parking space, the park assist system alone determining the target parking space and the calculated trajectory path thereto without any driver interaction;
(d) starting a parking maneuver wherein the vehicle is started to be guided into the target parking space by the park assist system;
(e) following step (d), deactivating the park assist system by a driver/passenger action;
(f) at the time of deactivation of step (e), storing the parking information determined above in step (c) by the park assist system; and
(g) following step (f), the park assist system requesting a driver command to resume the parking maneuver began in step (d), wherein if the driver selects to resume the parking maneuver the park assist system uses the stored parking information to guide the vehicle into the target parking space.

2. The method for parking the vehicle of claim 1 wherein in step (g) if the driver does not select to resume the parking maneuver the stored parking information is cleared from the park assist system.

3. The method for parking the vehicle of claim 1 wherein the at least one sensor is an ultrasonic sensor.

4. The method for parking the vehicle of claim 3 wherein the sensing system further includes at least one of an odometric sensor, an absolute steering wheel angle sensor, a relative steering wheel angle sensor, and a global positioning system, which are used in conjunction with the at least one ultrasonic sensor to scan the neighboring objects to determine if a feasible target parking space is available for parking the vehicle.

5. The method for parking the vehicle of claim 1 wherein the neighboring objects includes at least one object either in front of or behind the vehicle when parked in the target parking space.

6. The method for parking the vehicle of claim 1 wherein the target parking space is a parallel parking space between a forward first object and a rearward second object.

7. The method for parking the vehicle of claim 1 wherein the vehicle further includes electric power assisted steering system operatively connected to the park assist system.

8. The method for parking the vehicle of claim 1 further including the steps of prompting a driver of the vehicle that a feasible target parking space is available, instructing the driver to stop the vehicle, remove their hands from a steering wheel of the vehicle and engage reverse, and executing the calculated steering trajectory path provided by the park assist system in order to park the vehicle into the target parking space.

9. The method for parking the vehicle of claim 1 wherein the park assist system is a sensor only based system.

10. The method for parking the vehicle of claim 9 wherein the sensor only based system includes one or more sensors from the group consisting of an ultrasonic, odometric, absolute steering wheel angle, relative steering wheel angle, radar, thermal, optical, and laser sensors.

11. A method for parking a vehicle in a target parking spot comprising the steps of:
(a) providing a vehicle having a sensing system, a park assist system operatively connected to the sensing system, a steering system including a steering wheel, and a powertrain system, the sensing system including at least one sensor which provides an input signal to the park assist system;
(b) activating the sensing system to scan neighboring objects to determine if there is a feasible target parking space available for parking of the vehicle;
(c) using a computer of the park assist system to determine whether there is a sufficient slot length in which to park the vehicle in the target parking space and to determine a calculated trajectory path to guide the vehicle into the target parking space, the park assist system alone determining the target parking space and the calculated trajectory path thereto without any driver interaction;
(d) prompting the driver that a feasible target parking space is available;
(e) instructing the driver to stop the vehicle, remove their hands from the steering wheel of the steering system, and engage the powertrain system into reverse;
(f) starting a parking maneuver wherein the vehicle is started to be guided into the target parking space by the park assist system;
(g) following step (f), deactivating the park assist system by a driver/passenger action;
(h) at the time of deactivation of step (g), storing the parking information determined above in step (c) by the park assist system; and
(i) following step (h), the park assist system requesting a driver command to resume the parking maneuver began in step (f), wherein if the driver selects to resume the parking maneuver the park assist system uses the stored parking information to guide the vehicle into the target parking space.

12. The method for parking the vehicle of claim 11 wherein in step (i) if the driver does not select to resume the parking maneuver the stored parking information is cleared from the park assist system.

13. The method for parking the vehicle of claim 11 wherein the at least one sensor is an ultrasonic sensor.

14. The method for parking the vehicle of claim 13 wherein the sensing system further includes at least one of an odometric sensor, an absolute steering wheel angle sensor, a relative steering wheel angle sensor, and a global positioning system, which are used in conjunction with the at least one ultrasonic sensor to scan the neighboring objects to determine if a feasible target parking space is available for parking the vehicle.

15. The method for parking the vehicle of claim 11 wherein the neighboring objects includes at least one object either in front of or behind the vehicle when parked in the target parking space.

16. The method for parking the vehicle of claim 11 wherein the target parking space is a parallel parking space between a forward first object and a rearward second object.

17. The method for parking the vehicle of claim 11 wherein the park assist system is a sensor only based system.

18. The method for parking the vehicle of claim 11 wherein the vehicle further includes an electric power assisted steering system operatively connected to the park assist system.

19. A park assist system for parking a vehicle in a target parking space comprising:
a sensing system including at least one sensor which provides an input signal to the park assist system to determine if a feasible target parking space is available for parking the vehicle; and
a park assist system computer which determines whether there is a sufficient slot length in which to park the vehicle in the target parking space and to determine a calculated trajectory path to guide the vehicle into the target parking space, the park assist system alone determining the target parking space and the calculated trajectory path thereto without any driver interaction, the computer having a stored memory that can be retrieved upon deactivation of the park assist system;
wherein upon starting a parking maneuver in which the vehicle is started to be guided into the target parking space by the park assist system and the system is deactivated by a driver/passenger action, at the time of deactivation the computer of the park assist system stores the parking information determined above and requests a driver command to resume the parking maneuver which has began and, if the driver selects to resume the parking maneuver the park assist system uses the stored parking information, the park assist system is operative to guide the vehicle into the target parking space.

20. The park assist system for parking a vehicle of claim 19 wherein if the driver does not select to resume the parking maneuver the stored parking information is cleared from the park assist system.
